(19) United States
(12) Patent Application Publication
(10) Pub. No.: US 2017/0132640 A1
(43) Pub. Date: May 11, 2017

(54) METHOD AND APPARATUS FOR SHARING A VEHICLE'S STATE OF HEALTH

(71) Applicant: FORD GLOBAL TECHNOLOGIES, LLC, Dearborn, MI (US)

(72) Inventors: David A. HERMAN, Southfield, MI (US); Omar MAKKE, Lyon Township, MI (US); Nicholas COLELLA, Grosse Ile, MI (US)

(21) Appl. No.: 14/938,010

(22) Filed: Nov. 11, 2015

(51) Int. Cl. G06Q 30/00

(52) U.S. Cl. CPC G06Q 30/018

(57) ABSTRACT

An illustrative exemplary system includes a processor configured to send a vehicle health report to a ride-sharing matching system, in response to a request from the matching system, the report confirming that a vehicle meets minimum standards specified in the request after determining that the standards are met by the vehicle.

### TECHNICAL FIELD

The illustrative embodiments generally relate to a method and apparatus for sharing a vehicle's state of health.

### BACKGROUND

With the advent of opt-in transportation systems such as UBER and LYFT, concerns exist about the reliability of the vehicles used to transport passengers in these systems. Cities may require that registered taxis comply with certain maintenance requirements, but currently it is harder to ensure that opt-in vehicles comply with any preset set of standards.

Passengers, of course, want to ride in a reliable vehicle. While a visual inspection can identify broken items on the vehicle, it is unreasonable to expect a passenger to inspect the engine and subsystems of a vehicle.

### SUMMARY

In a first illustrative embodiment, a system includes a processor configured to send a vehicle health report to a ride-sharing matching system, responsive to a request from the matching system, confirming that a vehicle meets minimum standards specified in the request after determining that the standards are met by the vehicle.

In a second illustrative embodiment, a system includes a processor configured to relay a pickup request to a vehicle from which a health report was received, upon determining that the health report meets a minimum set of standards specified in the pickup request received from a passenger mobile device.

In a third illustrative embodiment, a system includes a processor configured to transmit a vehicle health report to a directly wirelessly-connected mobile device, upon receiving a report request from the mobile device, after determining that the device corresponds to a device from which a passenger pickup request was previously received.

### BRIEF DESCRIPTION OF THE DRAWINGS

FIG. 1 shows an illustrative vehicle computing system;

FIG. 2 shows an illustrative process for requesting a vehicle health report as a passenger;

FIG. 3 shows an illustrative process for health report verification;

FIG. 4 shows an illustrative process for maintenance score reporting; and

FIG. 5 shows an illustrative system for health report reporting.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

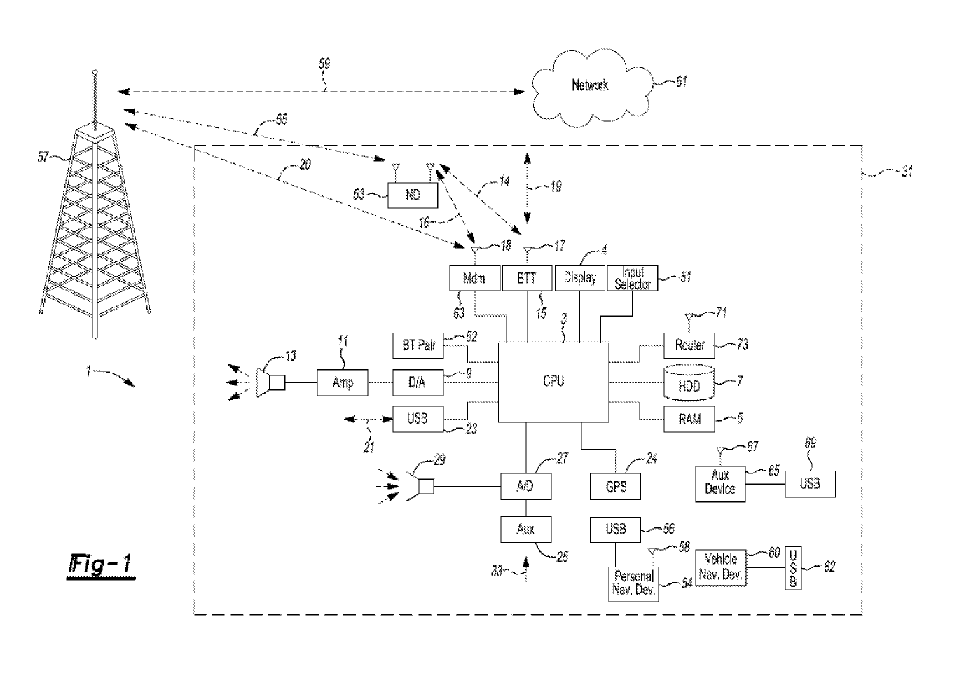

FIG. 1 illustrates an example block topology for a vehicle based computing system 1 (VCS) for a vehicle 31. An example of such a vehicle-based computing system 1 is the SYNC system manufactured by THE FORD MOTOR COMPANY. A vehicle enabled with a vehicle-based computing system may contain a visual front end interface 4 located in the vehicle. The user may also be able to interact with the interface if it is provided, for example, with a touch sensitive screen. In another illustrative embodiment, the interaction occurs through, button presses, spoken dialog system with automatic speech recognition and speech synthesis.

In the illustrative embodiment 1 shown in FIG. 1, a processor 3 controls at least some portion of the operation of the vehicle-based computing system. Provided within the vehicle, the processor allows onboard processing of commands and routines. Further, the processor is connected to both non-persistent 5 and persistent storage 7. In this illustrative embodiment, the non-persistent storage is random access memory (RAM) and the persistent storage is a hard disk drive (HDD) or flash memory. In general, persistent (non-transitory) memory can include all forms of memory that maintain data when a computer or other device is powered down. These include, but are not limited to, HDDs, CDs, DVDs, magnetic tapes, solid state drives, portable USB drives and any other suitable form of persistent memory.

The processor is also provided with a number of different inputs allowing the user to interface with the processor. In this illustrative embodiment, a microphone 29, an auxiliary input 25 (for input 33), a USB input 23, a GPS input 24, screen 4, which may be a touchscreen display, and a BLUETOOTH input 15 are all provided. An input selector 51 is also provided, to allow a user to swap between various inputs. Input to both the microphone and the auxiliary connector is converted from analog to digital by a converter 27 before being passed to the processor. Although not shown, numerous of the vehicle components and auxiliary components in communication with the VCS may use a vehicle network (such as, but not limited to, a CAN bus) to pass data to and from the VCS (or components thereof).

Outputs to the system can include, but are not limited to, a visual display 4 and a speaker 13 or stereo system output. The speaker is connected to an amplifier 11 and receives its signal from the processor 3 through a digital-to-analog converter 9. Output can also be made to a remote BLUETOOTH device such as PND 54 or a USB device such as vehicle navigation device 60 along the bi-directional data streams shown at 19 and 21 respectively.

In one illustrative embodiment, the system 1 uses the BLUETOOTH transceiver 15 to communicate 17 with a user's nomadic device 53 (e.g., cell phone, smart phone, PDA, or any other device having wireless remote network connectivity). The nomadic device can then be used to communicate 59 with a network 61 outside the vehicle 31 through, for example, communication 55 with a cellular tower 57. In some embodiments, tower 57 may be a WiFi access point.

Exemplary communication between the nomadic device and the BLUETOOTH transceiver is represented by signal 14.

Pairing a nomadic device 53 and the BLUETOOTH transceiver 15 can be instructed through a button 52 or similar input. Accordingly, the CPU is instructed that the onboard BLUETOOTH transceiver will be paired with a BLUETOOTH transceiver in a nomadic device.

Data may be communicated between CPU 3 and network 61 utilizing, for example, a data-plan, data over voice, or DTMF tones associated with nomadic device 53. Alternatively, it may be desirable to include an onboard modem 63 having antenna 18 in order to communicate 16 data between CPU 3 and network 61 over the voice band. The nomadic device 53 can then be used to communicate 59 with a network 61 outside the vehicle 31 through, for example, communication 55 with a cellular tower 57. In some embodiments, the modem 63 may establish communication 20 with the tower 57 for communicating with network 61. As a non-limiting example, modem 63 may be a USB cellular modem and communication 20 may be cellular communication.

In one illustrative embodiment, the processor is provided with an operating system including an API to communicate with modem application software. The modem application software may access an embedded module or firmware on the BLUETOOTH transceiver to complete wireless communication with a remote BLUETOOTH transceiver (such as that found in a nomadic device). Bluetooth is a subset of the IEEE 802 PAN (personal area network) protocols. IEEE 802 LAN (local area network) protocols include WiFi and have considerable cross-functionality with IEEE 802 PAN. Both are suitable for wireless communication within a vehicle. Another communication means that can be used in this realm is free-space optical communication (such as IrDA) and non-standardized consumer IR protocols.

In another embodiment, nomadic device 53 includes a modem for voice band or broadband data communication. In the data-over-voice embodiment, a technique known as frequency division multiplexing may be implemented when the owner of the nomadic device can talk over the device while data is being transferred. At other times, when the owner is not using the device, the data transfer can use the whole bandwidth (300 Hz to 3.4 kHz in one example). While frequency division multiplexing may be common for analog cellular communication between the vehicle and the internet, and is still used, it has been largely replaced by hybrids of Code Domain Multiple Access (CDMA), Time Domain Multiple Access (TDMA), Space-Domain Multiple Access (SDMA) for digital cellular communication. These are all ITU IMT-2000 (3G) compliant standards and offer data rates up to 2 mbs for stationary or walking users and 385 kbs for users in a moving vehicle. 3G standards are now being replaced by IMT-Advanced (4G) which offers 100 mbs for users in a vehicle and 1 gbs for stationary users. If the user has a data-plan associated with the nomadic device, it is possible that the data-plan allows for broad-band transmission and the system could use a much wider bandwidth (speeding up data transfer). In still another embodiment, nomadic device 53 is replaced with a cellular communication device (not shown) that is installed to vehicle 31. In yet another embodiment, the ND 53 may be a wireless local area network (LAN) device capable of communication over, for example (and without limitation), an 802.11g network (i.e., WiFi) or a WiMax network.

In one embodiment, incoming data can be passed through the nomadic device via a data-over-voice or data-plan, through the onboard BLUETOOTH transceiver and into the vehicle's internal processor 3. In the case of certain temporary data, for example, the data can be stored on the HDD or other storage media 7 until such time as the data is no longer needed.

Additional sources that may interface with the vehicle include a personal navigation device 54, having, for example, a USB connection 56 and/or an antenna 58, a vehicle navigation device 60 having a USB 62 or other connection, an onboard GPS device 24, or remote navigation system (not shown) having connectivity to network 61. USB is one of a class of serial networking protocols. IEEE 1394 (FireWire™ (Apple), i.LINK™ (Sony), and Lynx™ (Texas Instruments)), EIA (Electronics Industry Association) serial protocols, IEEE 1284 (Centronics Port), S/PDIF (Sony/Philips Digital Interconnect Format) and USB-IF (USB Implementers Forum) form the backbone of the device-device serial standards. Most of the protocols can be implemented for either electrical or optical communication.

Further, the CPU could be in communication with a variety of other auxiliary devices 65. These devices can be connected through a wireless 67 or wired 69 connection. Auxiliary device 65 may include, but are not limited to, personal media players, wireless health devices, portable computers, and the like.

Also, or alternatively, the CPU could be connected to a vehicle based wireless router 73, using for example a WiFi (IEEE 803.11) 71 transceiver. This could allow the CPU to connect to remote networks in range of the local router 73.

In addition to having exemplary processes executed by a vehicle computing system located in a vehicle, in certain embodiments, the exemplary processes may be executed by a computing system in communication with a vehicle computing system. Such a system may include, but is not limited to, a wireless device (e.g., and without limitation, a mobile phone) or a remote computing system (e.g., and without limitation, a server) connected through the wireless device. Collectively, such systems may be referred to as vehicle associated computing systems (VACS). In certain embodiments particular components of the VACS may perform particular portions of a process depending on the particular implementation of the system. By way of example and not limitation, if a process has a step of sending or receiving information with a paired wireless device, then it is likely that the wireless device is not performing that portion of the process, since the wireless device would not “send and receive” information with itself. One of ordinary skill in the art will understand when it is inappropriate to apply a particular computing system to a given solution.

In each of the illustrative embodiments discussed herein, a representative, non-limiting example of a process performable by a computing system is shown. With respect to each process, it is possible for the computing system executing the process to become, for the limited purpose of executing the process, configured as a special purpose processor to perform the process. All processes need not be performed in their entirety, and are understood to be examples of types of processes that may be performed to achieve elements of the invention. Additional steps may be added or removed from the exemplary processes as desired.

Passengers want to make sure the vehicle they are riding in is reliable. The illustrative examples could be used with UBER and LYFT opt-in type systems, as well as general taxi systems to ensure that a taxi is up to certain standards. The illustrative embodiments can be used, for example, to ensure that there are no diagnostic engine faults, brake faults or other critical faults in the vehicle before sharing the ride. The customer may also want to ensure that the rear child locks are not enabled.

Riders will use a telematics system compatible app which facilitates the transportation service (e.g., provides its own transportation service or integrates with an existing service application). Riders will request a shared ride from the cloud, optionally specifying “maintenance score.” The cloud services will find available vehicles ready to serve the customer and obtain a report from each vehicle. The report contains diagnostic information, including door lock and window status, air bag status, emergency system status, and other torque related troubleshoot codes. The vehicles can also calculate maintenance score to estimate how well the vehicle is maintained.

The customer then requests the shared ride from vehicles that meet requirements. If a driver opts to not share it, the application may flag the vehicle as unconfirmed.

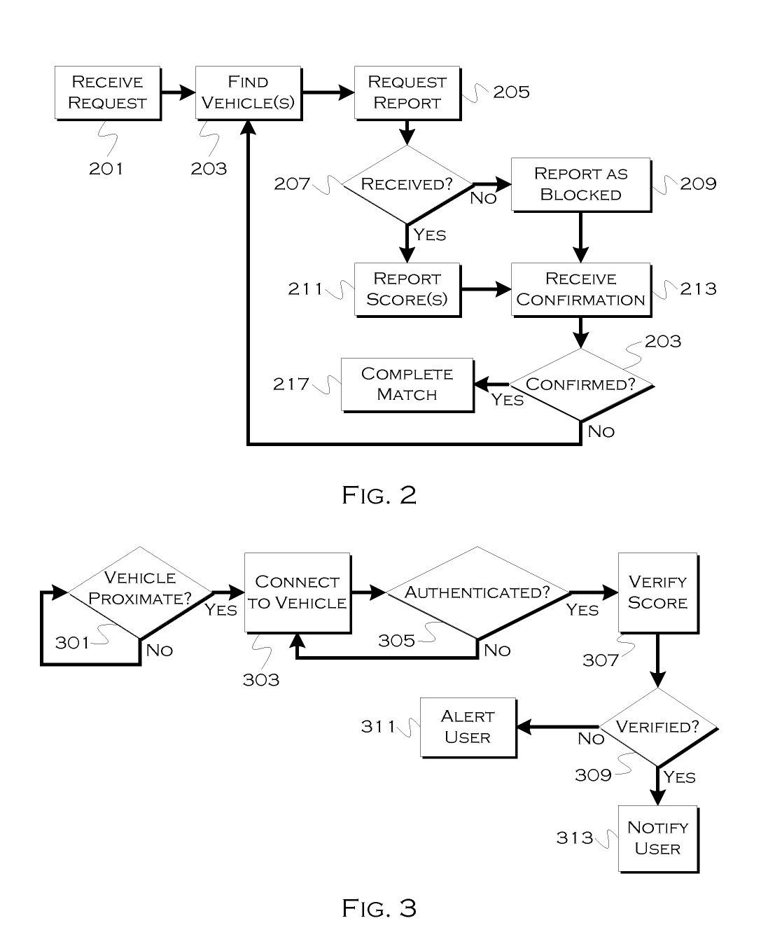

FIG. 2 shows an illustrative process for requesting a vehicle health report as a passenger, which may be included, for example, in a pickup request. With respect to the illustrative embodiments described in this figure, it is noted that a general purpose processor may be temporarily enabled as a special purpose processor for the purpose of executing some or all of the exemplary methods shown herein. When executing code providing instructions to perform some or all steps of the method, the processor may be temporarily repurposed as a special purpose processor, until such time as the method is completed. In another example, to the extent appropriate, firmware acting in accordance with a preconfigured processor may cause the processor to act as a special purpose processor provided for the purpose of performing the method or some reasonable variation thereof.

In this illustrative example, the process is running on an intermediary server that serves out the requests from passengers to drivers. This is an example of a process that can request both a driver and a vehicle score and/or ensure that only drivers complying with a specified maintenance score or not having certain defects may be eligible to fulfill a request.

The process receives a request 201 from a passenger using a mobile device equipped with a requesting application, in this case one provided by the original equipment manufacturer (OEM), but which could be provided by the after-market transportation service as well. Since the application is requesting vehicle data remotely, it may be desirable to have the OEM verify the application in some manner, as well as including some form of rights for the application user to access driver-vehicle data.

In addition to providing a passenger location, the request may include, for example, a minimum maintenance score or set of conditions (e.g., no low oil, no tire pressure below 31 PSI, etc.). In another example, the user can preconfigure a user-profile that specifies minimum standards. In still a further example, the user may specify a maintenance score or set of standards, but may also set a time conditional, such that if no proximate vehicles meeting the standards requirements are found, the request will then be passed to vehicles blocking their information, not providing information, or not meeting the standards.

It is also noted that current systems such as UBER and LYFT communicate with driver cell phones to provide passenger options. These phones may or may not be connected to a vehicle telematics system. In order for the requesting device to obtain vehicle data, either the driver phone may need to be connected to the vehicle telematics system to process the health report request, or the phone may have to identify a vehicle such that the intermediate system can connect to a vehicle modem, for example, in order to request the health report. In other examples, the driver request may be passed directly to the vehicle telematics system itself (through a phone or modem), if the UBER, LYFT or other applications are made so they can be integrated and run on the vehicle itself.

In this example, the process requests a report from one or more possible driver vehicles. In other examples, vehicles may transmit a report when they go “active” or each time they drop off a passenger and go “available.” This data can be temporarily stored and used by the system to select candidate vehicles, so that the system doesn't have to contact all possible driver vehicles in an area (which could be a large number of vehicles in a major city). In the example shown, the process contacts possible candidate vehicles 205, in order to ensure that health report information is as up-to-date as possible.

If a report is received 207, the process reports the score to a user for one or more candidate vehicles 211. In another example, the score is used to select candidate vehicles and offer the passenger option to those drivers. If a driver of a suitable vehicle confirms the trip, then the score for that vehicle may be sent to the phone user. If sending a score is a privacy concern, the process may simply utilize the health report to ensure the vehicle meets specified standards, without specifically sending the score to the passenger.

If a score is unobtainable, the process may report the score as “blocked” 209. This doesn't necessarily mean that the vehicle doesn't pass a set of standards, just that the score is unavailable. This vehicle may be distinguished for fall-back purposes from a vehicle which actually fails to meet the standards. If the user also confirms that the selected vehicle is acceptable (for example, if the score is reported to the user and the user confirms the score is suitable) 213, the process will accept the confirmation 215 and complete the match 217 to set up the trip. Otherwise, in this example, the process searches for newly available vehicles (and possibly excludes previously rejected vehicles).

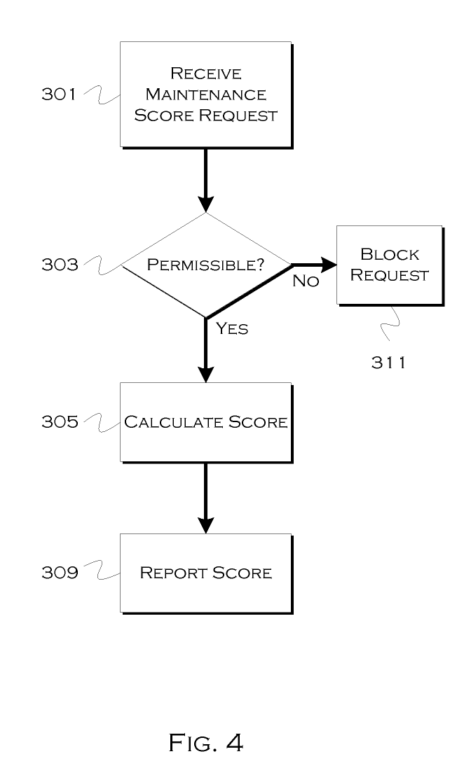

FIG. 3 shows an illustrative process for health report verification. With respect to the illustrative embodiments described in this figure, it is noted that a general purpose processor may be temporarily enabled as a special purpose processor for the purpose of executing some or all of the exemplary methods shown herein. When executing code providing instructions to perform some or all steps of the method, the processor may be temporarily repurposed as a special purpose processor, until such time as the method is completed. In another example, to the extent appropriate, firmware acting in accordance with a preconfigured processor may cause the processor to act as a special purpose processor provided for the purpose of performing the method or some reasonable variation thereof.

In this illustrative example, the passenger mobile device may connect directly to the vehicle in order to both verify a previously received score and ensure that certain vehicle systems (rear child locks, for example) are set to a passenger-preferred state. For example, a passenger may not specify a child-lock state for the request of a vehicle (since this is an easily adjustable feature), so that vehicles having engaged child locks are not excluded from a search. But, when the vehicle arrives, the process may check for certain features important to the passenger before the passenger enters the vehicle.

Once the vehicle is proximate to the passenger 301, the process connects directly to the vehicle (via BLUETOOTH, WiFi, or some other suitable wireless connection). The device may also be authenticated as being approved for such a request 303. The verification can be based on the fact that the requesting device corresponds to the selected passenger, or may utilize, for example, a temporary code that was sent from the vehicle when the passenger was accepted.

The request and response may take a number of forms. If specific information about the vehicle is protected, the request can specify a score and/or number of parameters, and the response to verify previously reported information 307 can simply be a “yes” or “no” (confirming the score was matched and/or the parameters were met). In the case of a no, the process may notify the user which parameter was not met, if appropriate, especially if the problem can be easily fixed (e.g., unlock the child locks). In other examples, a full report can be received by the user so that the user themselves can examine the report sent directly from the vehicle.

Once the information has been verified 309, the process can notify the user that the score and/or parameters were met 313 or not met 311.

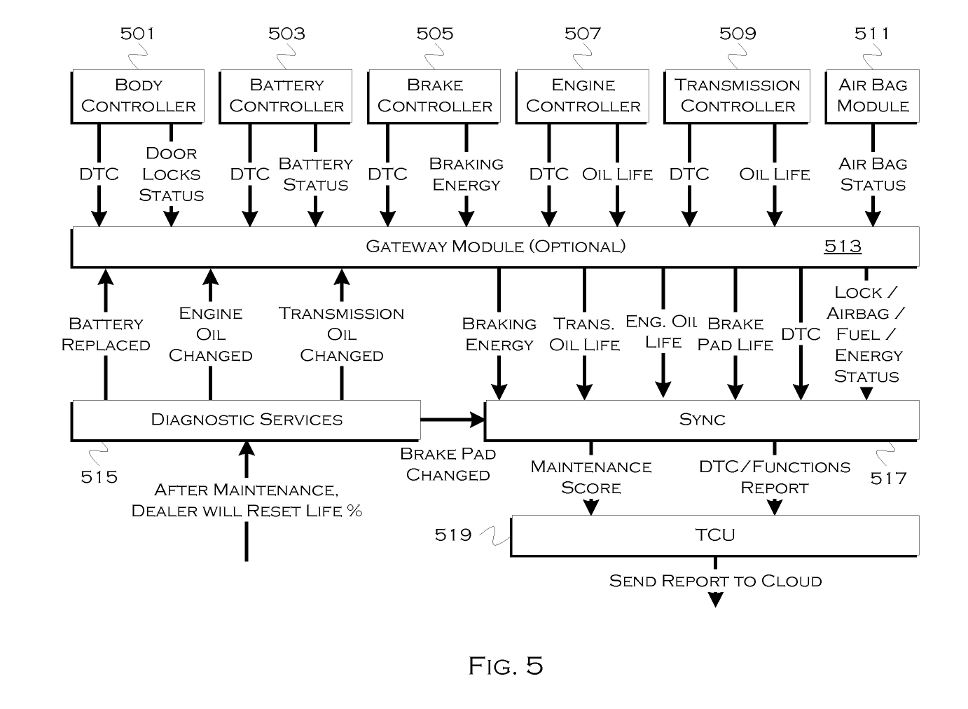

FIG. 4 shows an illustrative process for maintenance score reporting. With respect to the illustrative embodiments described in this figure, it is noted that a general purpose processor may be temporarily enabled as a special purpose processor for the purpose of executing some or all of the exemplary methods shown herein. When executing code providing instructions to perform some or all steps of the method, the processor may be temporarily repurposed as a special purpose processor, until such time as the method is completed. In another example, to the extent appropriate, firmware acting in accordance with a preconfigured processor may cause the processor to act as a special purpose processor provided for the purpose of performing the method or some reasonable variation thereof.

In this illustrative example, the process runs on a vehicle telematics system, for example, and reports the vehicle's state of health upon request from the ride-sharing application. Here, the process receives a request for a maintenance score 401. In other examples, a set of parameters to which the system may answer “yes” or “no” may be received. If the request is permissible 403 (i.e., if the driver has allowed such requests to be processed, and/or if the request is from a verified source), the process may calculate a health report 407.

The calculated health report may then be reported to the requesting system or device 409. In other examples, the state of various vehicle systems may be reported to a requesting system or device 409. In still other examples, a “pass” or “fail” report may be sent, in order to protect the vehicle-specific data and just to let a passenger know if the vehicle passes passenger specified minimum standards. If the driver has blocked such requests (or if the system is incapable of reporting), the process may block the request 405 or simply fail to report.

FIG. 5 shows an illustrative system for health report reporting. This illustrative system shows a number of non-limiting vehicle systems and sub-systems for which data can be reported. In this illustrative example, a gateway module 513 controls the aggregation of data and handles the reporting from various vehicle systems. This module can also serve to intervene between requests and reporting, and determine what form the reporting should take (e.g., the oil level may be reported as 20%, which the gateway may aggregate and report as “low”).

Here, the body controller 501 reports any body diagnostic trouble codes (DTC) and a door lock status. Many of the subsystems can report DTCs, as can be seen by the figure. The battery controller 503 reports any DTCs and a state of the battery charge. The brake controller 505 reports braking energy, brake conditions and any DTCs for the brakes. The engine controller 507 reports engine DTCs and the current oil life. The transmission controller 509 may also report oil life and any DTCs. An airbag module 511 may report the status of airbags as well as identifying which airbags are present.

After a dealer performs maintenance on the vehicle, the system can utilize a diagnostic services module 515 to report when the battery was replaced and/or when the oil was last changed. Any and all of this information may be reported to an infotainment computing system 517, which can assemble a maintenance score and/or a trouble code or functions report (e.g., door lock status) and pass this information to the telematics control unit 519, which can relay the information to a requesting system.

By providing a passenger with an option to remotely examine a vehicle health status, the passenger can ensure, long before a ride is confirmed, that the vehicle meets certain minimum standards. By permitting direct connection when the vehicle arrives, the passenger can ensure that the report was not faked and or certain systems are set to a desired state.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A system comprising:
a processor configured to:
send a vehicle health report to a ride-sharing matching system in response to a request from the matching system, the report confirming that a vehicle meets minimum standards specified in the request after determining that the standards are met by the vehicle.

2. The system of claim 1, wherein the vehicle health report includes any maintenance needs associated with any vehicle systems identified as part of the standards by the request.

3. The system of claim 1, wherein the vehicle health report includes any system state settings identified as part of the standards in the request.

4. The system of claim 1, wherein the vehicle health report is limited to a “yes” if the standards are met and “no” if the standards are not met.

5. The system of claim 1, wherein the processor is further configured to present an option to accept a passenger request, if the standards specified in the request are met.

6. The system of claim 1, wherein the processor is further configured to connect directly to a passenger device when the vehicle is within wireless communication range of the passenger device using a vehicle local wireless communication system, and to verify the accuracy of the vehicle health report once the passenger device is connected.

7. The system of claim 6, wherein the processor is configured to verify the permissibility of the passenger device based on the device corresponding to a device from which a ride-sharing request was sent.

8. The system of claim 6, wherein the processor is configured to verify the permissibility of the passenger device based on a code sent to the passenger device when the vehicle health report was sent.

9. A system comprising:
a processor configured to:
relay a pickup request to a vehicle from which a health report was received, upon determining that the health report meets a minimum set of standards specified in the pickup request received from a passenger mobile device.

10. The system of claim 9, wherein the vehicle health report includes maintenance needs associated with vehicle systems identified as part of the standards by the request.

11. The system of claim 10, wherein the processor is further configured to send the maintenance needs to the passenger mobile device if a driver of the vehicle responds affirmatively to the pickup request.

12. The system of claim 9, wherein the vehicle health report includes system state settings identified as part of the standards in the request.

13. The system of claim 12, wherein the processor is further configured to send the state settings to the passenger mobile device if a driver of the vehicle responds affirmatively to the pickup request.

14. The system of claim 9, wherein the processor is further configured to send information about the health report to the passenger mobile device, to determine that both a passenger and a driver of the vehicle have approved of a pickup, and to facilitate a ride-share between the driver and the passenger if both the driver and the passenger have approved.

15. The system of claim 14, wherein the information about the health report is limited to one or more of “pass” or “fail” based on whether or not vehicle systems or state settings correspond to passenger specified requirements.

16. The system of claim 15, wherein the pickup request from the passenger mobile device includes the passenger specified requirements.

17. The system of claim 15, wherein the processor is configured to retrieve the passenger specified requirements from a stored passenger profile having predefined passenger specified requirements.

18. A system comprising:
a processor configured to:
transmit a vehicle health report to a directly wirelessly-connected mobile device, upon receiving a report request from the mobile device, after determining that the device corresponds to a device from which a passenger pickup request was previously received.

19. The system of claim 18, wherein the processor is configured to determine that the device corresponds to the device from which the passenger pickup request was previously received based on a device identifier included in the report request and previously sent by an intermediary system that facilitated the pickup request.

20. The system of claim 18, wherein the processor is configured to determine that the device corresponds to the device from which the passenger pickup request was previously received based on a code included in the report request and previously sent by the processor to the mobile device upon originally receiving the pickup request.
